(19) United States
(12) Patent Application Publication
(10) Pub. No.: US 2025/0165633 A1
(43) Pub. Date: May 22, 2025

(54) SYSTEM AND METHOD FOR ENHANCED VISUALIZATION OF EXFILTRATION ACTIVITIES

(71) Applicant: Code42 Software, Inc., Minneapolis, MN (US)

(72) Inventors: Peter John Lindquist, St. Paul, MN (US); Austin Wolf, Minneapolis, MN (US); Kelly MacFarlane, Minneapolis, MN (US); Jonathan Klemm, Minneapolis, MN (US)

(21) Appl. No.: 18/516,451

(22) Filed: Nov. 21, 2023

(51) Int. Cl. G06F 21/62; G06F 21/55

(52) U.S. Cl. CPC G06F 21/6218; G06F 21/552; G06F 21/554

(57) ABSTRACT

A system is configured to perform operations including receiving an indication of a filesystem event detected by an event monitor; determining a platform domain from the indication of the filesystem event; storing content of the filesystem event in a data store with content from a plurality of filesystem events; and displaying in a graphical user interface, attributes of the plurality of filesystem events, grouped by platform domain.

### TECHNICAL FIELD

Embodiments of the present disclosure relate generally to computer security, more particularly, but not by way of limitation, to providing enhanced visualization of exfiltration activities.

### BACKGROUND

Companies with valuable data stored electronically such as source code, customer lists, engineering designs, sensitive emails, and other documents are increasingly subject data leaks or data theft. Outsiders may attempt to hack computer networks using viruses; worms; social engineering; or other techniques to gain access to data storage devices where valuable data is stored. Another threat is exfiltration of data by insiders. Data exfiltration is the unauthorized transfer of data. It is a type of data loss, which may expose sensitive, secret, or personal data. These insiders may be motivated to steal employer data by greed, revenge, a desire to help a new employer, or other motivations. Detecting insider threats is particularly difficult because insiders, such as employees or contractors, may have been granted authorized access to the very files they aim to steal. This makes detecting data exfiltration especially difficult due to the numerous available data exfiltration vectors (i.e., pathways) that an employee may use to move data between computing resources. As a result, during the normal course of business, any employee that has access to data, documents, or other digital assets of an organization is a potential risk to the security of those assets.

### BRIEF DESCRIPTION OF THE DRAWINGS

Various ones of the appended drawings merely illustrate example embodiments of the present disclosure and cannot be considered as limiting its scope. Additionally, the headings provided herein are merely for convenience and do not necessarily affect the scope or meaning of the terms used.

FIG. 1 is a block diagram illustrating a system for file analysis, according to an example.

FIG. 2 is a block diagram illustrating a forensics component of administrative the server system, according to an example.

FIG. 3 is a block diagram illustrating a process to obtain domain information related to an alert, according to an example.

FIG. 4 is a block diagram illustrating a process to parse an alert and associated context information, according to an example.

FIG. 5 is a diagram illustrating a user interface, according to an example.

FIG. 6 is a diagram illustrating another user interface, according to an example.

FIG. 7 illustrates an example of a process for generating a user interface, according to an example.

FIG. 8 illustrates a diagrammatic representation of a machine in the form of a computer system within which a set of instructions may be executed for causing the machine to perform any one or more of the methodologies discussed herein, according to an example.

### DETAILED DESCRIPTION

Corporations, firms, business entities, and other institutions (hereinafter, “organizations”) can manage distributed information technology infrastructures that provide computing and intellectual property resources to employees, clients, and other users. Organizations are typically obliged to invest a considerable amount financial and human capital in securing intellectual property resources from unauthorized access or removal from their possession. This is due, in part, to the numerous available data exfiltration vectors that make it easy or convenient to any employee legally, or illegally, to move data between computing resources. As a result, during the normal course of business, any employee that has access to the intellectual property resources of an organization is a potential risk to the security of those resources.

A given organization can make its intellectual property resources available to authorized users though one or more computing resources, such as user computing devices, computing servers, or hosted or network-based computing environments and storage systems. Such computing resources can be configured with filesystems having filesystem elements (e.g., file, directory, archive, metadata, etc.) that facilitate the storage, manipulation, and communication of large amounts of data, such as the intellectual property resources.

File exfiltration detection techniques enable organizations to detect files leaving, or being removed from, a digital perimeter of the organization. Various techniques may be used to track the movement of a file within or across an organization or to detect when a file is transmitted through a digital perimeter of an organization. For example, a monitoring application may detect a user accessing certain files that the user would not normally access, accessing certain files at hours they would not normally access the files at, detecting large transfers of files to or from an external storage device, detecting movement of files to or from a directory linked to a cloud storage account, or the like. Other exfiltration detection techniques may monitor activities performed via client applications, such as web browsers, productivity software, or file synching tools. Filesystem event monitoring may be performed using operating system interfaces. A filesystem event (also referred to as an “event”) can include any operation to create, read, modify, delete, share, link, upload, or transmit a file, directory, or other filesystem element. Additional techniques may include identifying and tracking entire files based on a digital signature, such as by way of a file digest hash, or using portions of a file to track its contents. For instance, a system may use large-token text comparisons to determine whether files contain related content. Other techniques may use file relationships and track one file's location and activity to infer another file's sensitivity.

Regardless of which technique is used to track file activity, the amount of suspicious filesystem events in an organization can quickly become overwhelming. With the increased usage of cloud services and offline data repositories, an organization's data may be transmitted to offsite servers on a regular basis. Effective and efficient monitoring and tracking tools are needed to assist human operators to determine which filesystem exfiltration activities are suspicious or benign. This document outlines various mechanisms used to track filesystem events, log the events, and generate intuitive user interfaces for managers and administrators to quickly ascertain possible threats to an organization's data security. Improved user interfaces, presentations, and other computer-aided displays are discussed herein.

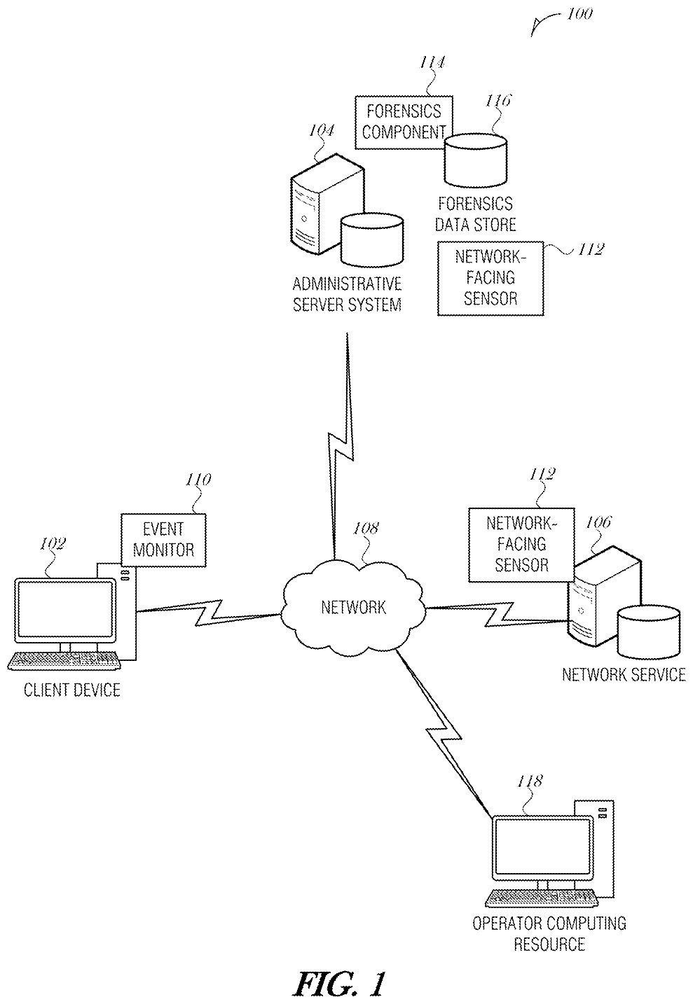

FIG. 1 is a block diagram illustrating a system 100 for file analysis, according to an example. The system 100 is configured to analyze files and produce an output for a human operator. The system 100 includes a client device 102, an administrative server system 104, and a network service 106, all of which are connected via a data communication network 108. The data communication network 108 may include wired, wireless, local area networks, wide area networks, or the like. Components of the system 100 can communicate using the data communication network 108 or any other suitable data communication channel.

Client device 102 may be any suitable computing resource for accessing files, such as for creating, reading, writing, or deleting one or more files on the client device 102 or at a remote location (e.g., on a network storage device). The client device 102 may be in the form of an endpoint device, a computing server, a mobile device, a laptop, a desktop computing device, or the like.

A user of the client device 102 may interface with the network service 106 to create, modify, or delete files that are hosted at the network service 106. Examples of network services 106 include but are not limited to cloud-based office applications, online storage repositories, online commerce platforms, or the like. The user may use a web browser or other client application executing on the client device 102 to access the network service 106. For instance, the user may use a web browser to navigate to a page for a cloud-based storage and sharing service (e.g., DROPBOX (TM), OneDrive (TM) or similar), and upload the files through that page. Alternatively, the user may use a client application to perform similar file functions (e.g., DROPBOX (TM) client application and synchronization functions).

The client device 102 may include an event monitor 110 that is configured to detect or monitor filesystem events. A filesystem event (also referred to as an “event”) can include any operation to create, read, modify, or delete a file, directory, or other filesystem element. In an example, the event monitor 110 is configured to detect file read, file write events, file delete, and file create events. Responsive to detecting a filesystem event, the event monitor 110 is configured to store metadata about the event, such as whether a read or a write operation was performed, an identifier of, or a filesystem reference to, the file on which the operation was performed, a date and time of the event, a user identifier of the person initiating the filesystem event, a filesystem identifier of the file, such as a filename and a file path, a source directory path and a destination directory path, and the like.

Filesystem events may be detected by various mechanisms, such as by monitoring input/output (I/O) requests, tracking file locations or movement using digital signatures, comparing files using large-token text comparison techniques, or using file relationships to infer potential exfiltration activities. For instance, monitoring input/output (I/O) requests and may perform one or more filtering processes to detect filesystem events and to filter out I/O requests that indicate normal behavior and other behavior that is not indicative of exfiltration.

Filesystem events that are indicative of exfiltration may be further processed at the client device 102, such as by interrogating the web browser or other application or its components to gather contextual information about the user's activities related to the filesystem event.

For example, on devices executing a MICROSOFT® WINDOWS® operating system (O/S), the event monitor 110 may include or interface with a kernel filter that is attached to an I/O stack of an O/S kernel. I/O requests of an application are delivered to the driver stack by the O/S to perform the command. A kernel filter acts as a virtual device driver and processes the I/O request. Once processing is finished, the kernel filter passes the I/O request to the next filter or to the next driver in the stack. In this way, a kernel filter has access to all I/O requests within a system; including I/O requests that represent filesystem events that relate to filesystem elements. In some examples, rather than being a filter, the first component may be a minifilter that is registered with a filter manager of an input/output stack of a Windows kernel.

As another example, on devices executing an Apple operating system such as a macOS® the event monitor 110 may include or interface with an event stream that provides I/O requests as one or more events in the stream. Event streams may be provided by a Basic Security Module (BSM), Endpoint Security Framework, or the like. The event monitor 110 may be implemented as a user mode component or a kernel mode component.

The event monitor 110 may also implement hashing of some or all of a file's contents to generate a digital signature of the file. The signature may be used to track the location, movement, or identification of the file. Additionally, hashes of portions of a file may be used to identify whether that portion exists in other files, which may be related files or unrelated files. The event monitor 110 may also inspect the contents of a file to determine whether it includes keywords, key phrases, or other indications of potentially sensitive information (e.g., content that has financial, intellectual, or other business value to an organization).

The filesystem events may be examined using an exfiltration model. The event monitor 110 may use an exfiltration model to determine whether a filesystem event is indicative of exfiltration. The exfiltration model may be rules based, use machine learning, or be configured by other mechanisms. In some examples, a single event may be used to flag the filesystem event as indicative of exfiltration. For example, if specific files or folders (e.g., sensitive files) are involved in a filesystem event or if a threshold number of files or a threshold number of bytes are transferred to a remote system, then this may be considered highly suspect and indicative of exfiltration. Other suspicious events may include a large number of files being copied to a removable Universal Serial Bus (USB) drive, a large amount of data transfer over a network, and the like. In some examples, a series of filesystem events may be examined with exfiltration models to detect patterns of behavior.

Filesystem events from may be associated with metadata about the filesystem event, the filesystem element, and the application. This metadata may include context information about the user's activities within the application that caused the filesystem event. Context information may include data such as the website address (subdomain, domain, etc.) that the user was using to generate the filesystem event(s) that is indicative of exfiltration, an account that the user was logged into during the event, a directory structure of a cloud-based file sharing or storage site where the files were uploaded to, a recipient of the files (if the site is an email site), and the like. This context information may be obtained, for example, by querying a web browser through an Application Programming Interface (API), querying a database of the web browser, by screen capture techniques to capture a user interface of the web browser, or by analyzing local security logs or filesystem structures.

Account information may be used to determine whether the account associated with the transfer is a work account (which may be permissible) or a personal account (which may not be permissible). This information may be determined using screen scraping techniques—e.g., sites may list the username of the user that is logged in and this information may be scraped from a web page. Similarly, information about the user's account on the cloud-based file sharing or storage service such as a directory structure or other files uploaded may also be gathered using screen scraping techniques. If the site is a web-based email, the recipient of the email message may be gathered through scraping techniques as well.

The event monitor 110 may further filter the filesystem event notifications and apply additional detection logic to try and increase accuracy and eliminate false positives when raising an alert. This may include applying one or more permit and reject lists. For example, if a site determined from the browser is in the permit list, the anomaly is not further processed. If the site name determined from the browser is in the reject list, then an alert may be generated, and further exfiltration processing may continue. One or more of the permit lists or reject lists may be utilized alone or in combination. Alerts may be based on one or more filesystem events. For instance, an alert may be generated after a threshold number of filesystem events have occurred (e.g., a large amount of files being copied). As another example, an alert may be generated after a single filesystem event (e.g., a sensitive file is emailed to an unknown email domain).

Filesystem events may be logged at the client device 102 and reported to the administrative server system 104. The reporting may be realtime or may be performed on a scheduled basis. The administrative server system 104 may utilize any events or alerts from the exfiltration application, along with other alerts or signals from detecting other anomalies to determine whether to notify an administrator. For example, a set of rules may determine which alerts, or combination of alerts, may trigger a notification to an administrator. The administrator may be alerted through a management computing device, such as part of a Graphical User Interface (GUI), a text message, an email, or the like. The alert may include information such as a hash of the file, date, time, Multipurpose Internet Mail Extensions (MIME) type, name of the website, and the like

In addition to monitoring the client device 102, network-facing sensors 112 may be used to monitor network assets. Network facing sensors 112 may be hosted at the administrative server system 104 or be enabled with services executing at the network service 106 (e.g., filesystem activities may be exposed through an API or through reporting, or an agent operating at the network service 106 may be used to monitor filesystem activity). Network facing sensors 112 are used to monitor network services, platforms, or other external systems. Here, external systems refer to systems that are outside of the direct control of an organization. For instance, an organization may use cloud services provided by Dropbox (TM), where the cloud services are provided by a data center that is outside of the direct control of the organization. Network-facing sensors 112 may monitor files that are stored at a network location, such as network service 106. Alerts can be generated by network-facing sensors 112 that monitor filesystem events and other events, and the alerts can be reported to the administrative server system 104 for additional analysis. The alert may include information such as a hash of the file, date, time, Multipurpose Internet Mail Extensions (MIME) type, name of the website, and the like

A forensics component 114 is used to perform forensics on filesystem elements identified in the alerts to determine relationships to associated files, directories, or users, the type of data contained in a file, a filetype of the file, security settings on the file, file signature, and the like. Additionally, the forensics component 114 can identify filesystem events that are associated with the alerts. Filesystem events may include copying data from a client site device to a network site device, moving data from a network site device to a client site device, detecting data exports to a personal device (e.g., a shadow information technology (IT) asset), or the like. The results of forensic analysis can be stored in a forensic file data store 116 or a file backup data store in the administrative server system 104. The forensic file store 116 may be accessed through a query service.

Operator computing resource 118 can include any computing resource that is configured with one or more software applications to interface with the administrative server system 104 to initiate analysis, such as by transmitting a request or query to the administrative server system 104.

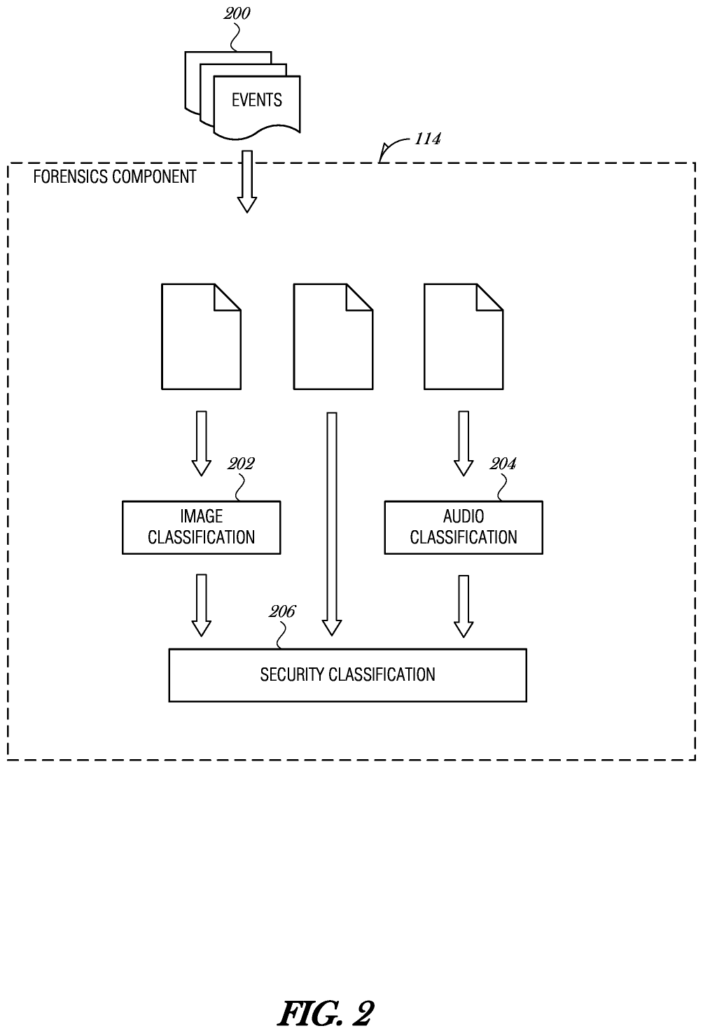

FIG. 2 is a block diagram illustrating a forensics component 114 of administrative the server system 104, according to an example. The forensics component 114 may be hosted by one or more computers in the administrative server system 104. Because the event monitor 110 is installed at the client device 102 and has access to the file, the forensics component 114 has visibility into file contents, file attributes, and transaction data that is unavailable to other security platforms. This is a distinct advantage over remote network monitoring tools that cannot inspect file contents, view login or other contextual data, or perform deep analysis amongst several possible related files.

The forensics component 114 receives events 200 from one or more monitors, which may monitor client devices or network locations. The events 200 may have been categorized into various risk levels (or risk scores) by the monitoring mechanism. The risk levels (or risk scores) may include a low, moderate, high, and critical risk score. The risk levels may be based on the type or number of related filesystem events.

Events 200 may be used to initiate post-analysis processes, such as mitigation activities like sending an alert to a human resources department, sending an educational video to a user to inform or instruct the user of procedures to avoid risk activities, interfacing with network utilities or computer access control modules to block access to network assets, removing user account privileges, restricting access to certain directories, or the like. Mitigation activities may be automated or may be implemented manually with the use of an administrative dashboard.

The image classification system 202 may be used to analyze image files identified in an exfiltration event to determine the contents of the file. For instance, optical character recognition (OCR), object detection and classification, and other analyses may be used to determine the contents of the file. The output from the image classification system 202 may be used by a security classification system 206 to further determine if the file content is sensitive in nature.

Audio classification system 204 may analyze audio files identified in an exfiltration event to perform speech to text conversion and determine file content. The output from the audio classification system 204 may be used by the security classification system 206 to further determine if the file content is sensitive in nature.

The security classification system 206 may analyze files identified in an exfiltration event to determine if the files include intellectual property, personal information (e.g., social security numbers, employee identifiers, bank account numbers, etc.), trade secrets, or other sensitive information.

The events 200 may have one or more related filesystem events. The context information of the related filesystem events may be transmitted in the event message 200. The forensics component 114 determines an exfiltration vector (e.g., source/destination of file transfer) and the domain and any subdomain of a network location used in the filesystem event based on the context information. The domain or subdomain may be used to better visualize heavily used exfiltration vectors. Visualizations may be used to better organize the events 200, the exfiltration vectors (e.g., source/destination of file transfer), and other context information (e.g., user information, file type, file contents, create/modify date of file changes, directory path, etc.).

The techniques described herein can significantly reduce the number of filesystem events that an operator has to consider or analyze. Efficient visualizations provide a quick way for an operator to filter various types or levels of contextual events, filesystem events, and other context information to identify higher risk threats.

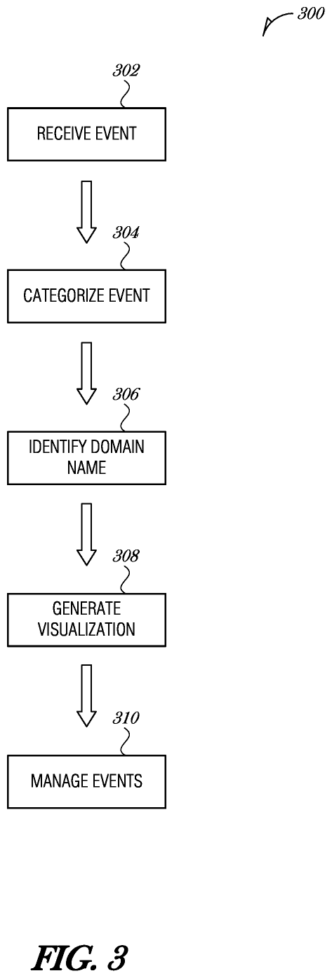

FIG. 3 is a block diagram illustrating a process 300 to obtain domain information related to a filesystem event, according to an example. At 302, an indication of an event is received. The event may be produced by a monitor, such as described above. The event may include or be associated with context information. The context information includes various data about the event and the context within which it occurred. Example context information includes, but is not limited to a website address (subdomain, domain, etc.) that the user was using to generate the filesystem event(s) that is indicative of exfiltration, an account that the user was logged into during the event, a directory structure of a cloud-based file sharing or storage site where the files were uploaded to, a recipient of the files (if the site is an email site), user information, file type, file contents, create/modify date of file changes, source and destination directory path, and the like

At 304, the event is categorized. The event may be categorized by the monitor that captured or detected the event. Alternatively, the event may be categorized at the administrative system, such as by the forensics component. The event category may be low, medium, high, or critical to indicate a severity of the potential exfiltration activity. The event may be based on one or more aspects of the context information. Additionally, the event may be categorized based on the type of use of the networked service, such as a corporate or personal use.

At 306, a domain name is identified. The domain name is a string that identifies a realm or service provided through the Internet, such as a website, email service, microservice, or the like. The domain name may be part of a request, such as a copy or save file operation, part of a source or destination directory, or may be included in other metadata or context information associated with an event.

The domain name refers to the main subdomain (also referred to as a second-level domain) from a top-level domain. Common top-level domains include “.com”, “.net”, “.org”, and “.edu”. Popular main subdomains include “Amazon.com” and “Google.com”. After the second-level domain, typically, are subdomain names that refer to a name or subdivision of a company, a product or service, or an implied function. For example, “mail.apple.com” may be a mail server for the company Apple, Inc. As another example, “www.example.co.uk” may be a web server for the company “example”. The subdomain names that refer to applications, products, or services may be referred to as a hostname. A hostname is a domain name that has at least one associated internet protocol (IP) address. For example, the domain names “www.example.com” and “example.com” may be hostnames because they resolve to IP addresses, whereas the “com” domain is not. However, other top-level domains, particularly country code top-level domains, may indeed have an IP address, and if so, they are also hostnames. One or more domain name servers (DNS) may be used to verify that a main subdomain or hostname domain is registered.

At 308, a visualization is generated with aggregated domains. Often, platform domains, also referred to as main subdomains, (e.g., “apple.com”) are masked by application subdomains or other hostnames (e.g., “mail.apple.com”). Extracting the registered domain from the context information or the event allows aggregation of similar exfiltration vectors. These events s may be related or have some other underlying commonality. By grouping or aggregating the vectors together under the main platform domain, the human administrative operator is provided an easier way to understand potential threats.

Additionally, events s from different users or caused by different filesystem events are aggregated under the same main platform domain, which more accurately reflects use of a platform across users within an organization.

At 310, the operator may manage the events s using a graphical user interface coupled to the visualization. The operator is able to manage event activity at a higher level, for example, by creating mitigation operations such as sending an alert to a human resources department, sending an educational video to a user to inform or instruct the user of procedures to avoid risk activities, interfacing with network utilities or computer access control modules to block access to network assets, removing user account privileges, restricting access to certain directories, or the like. Overall, the volume of decisions is reduced for the operator due to the streamlined visualization.

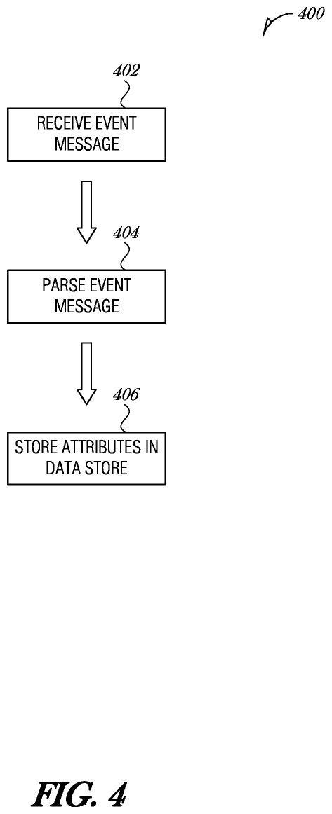

FIG. 4 is a block diagram illustrating a process 400 to parse a filesystem event and associated context information, according to an example. The process 400 may be executed by or integrated with elements or components of the system 100 described in FIG. 1, such as the administrative server system 104 or the forensics component 114. The process 400 receives information about filesystem events from other parts of the system 100 (operation 402), such as the event monitor 110 or network-facing sensors 112, in an event message.

In an example, the event message includes event metadata that is generated by the event monitor 110 or network-facing sensors 112. The event metadata may include various data about an event, such as a filename, a file type, a source (e.g., a path, a directory, a network location, a source address (e.g., URL, IP address, email address, etc.), a source application, a source repository, a source file type, etc.), a destination (e.g., a path, a directory, a network location, a destination address (e.g., URL, IP address, email address, etc.), a destination application, a destination repository, a destination file type, etc.), a file operation (e.g., read, write, copy, paste, etc.), a user (e.g., an active user, a user account used to effect the file operation, etc.), a unique event identifier (ID), a date and time stamp, and the like. Event metadata may be provided in a structure data format, such XML, JSON, or the like.

At 404, the process 400 parses the event message to identify data in the event message and map it to attributes that can be displayed in a user interface. Attributes may be created, defined, or managed by an administrative user or by an automated process. The automated process may create attributes based on analyzing event metadata. This type of auto-detection may evaluate whether use of a certain platform is prevalent within an environment. The automated process may use machine learning to auto-detect prevalent software platforms and identify attributes. Prevalence may be measured by calculating a number of users that regularly use the software platform. A threshold value may be used to determine whether a software platform's use is considered “prevalent.” For instance, the threshold value may be that 25% of the organization's members use the software platform. As another example, the threshold value may be that 1,000 people use the software platform. Prevalence may also be measured by a number of filesystem events that have been generated for a given software platform.

Other techniques may be used to determine a prevalent software platform including counting unique days of activity observed for a user over a timeframe (e.g., if a user uses a software platform 25 of the last 30 days, then it may be considered a prevalent software platform), a number of unique user-day pairs (e.g., more than a threshold value or percentage of unique users and days together, this may be constrained or measured over a period of time), a number of activity sessions across all users and days, and the like. These techniques detect regular use by a number of users, as opposed to strictly measuring the percentage of the users in an organization.

In an example, attributes include an “activity type,” “vector,” “category,” and “common hostname.” The “activity type” attribute may have various values that represent a categorization of a filesystem event activity. In examples, the “activity type” attribute may be one of unapproved, unmapped, personal, shadow information technology (IT), or corporate activity. Unapproved activities are filesystem events that are not expressly approved by an organization. Unmapped activities are those that are unclassified. These may be activities that have unusual or ambiguous vectors, categories, or common hostnames. Personal activities are events that are related to personal (not business) activity, such as personal emails from corporate accounts, internet browsing for personal interests, or the like. Shadow IT is any information technology (IT) an employee uses without approval, including software, applications, services, and devices. As such, shadow IT activities are those that are created by unsanctioned, unapproved, or other untracked shadow IT assets (e.g., personal computers, personal flash drives, smartphones, etc.). Corporate activity describes events that are performed in the course of usual business, such as business emails, copying corporate data to an offline database, interacting with a corporate intranet, and the like.

The “vector” attribute includes various values that describe the software application or service used during the filesystem event. In most instances, the “vector” attribute is used to indicate the destination of a filesystem operation (e.g., where the file was copied, pasted, or moved to). The “vector” attribute may have values representing a domain name, such as “google.com” that indicates that the application was an online application hosted by “google.com” such as “gmail.google.com”. Other example “vector” attribute values include other online services, such as “yahoo.com”, “reddit.com”, and “dropbox.com”.

The “category” attribute represents a description of the type of service being offered by the software application or service (i.e., vector). The “category” attribute values may include but are not limited to email, cloud storage, messaging, productivity, and social media. Email may refer to internet email platforms, such as outlook.com, comcast.net, gmail.com, and the like. Cloud storage may refer to online repositories such as dropbox.com, box.com, or Google Drive. Messaging may refer to messaging apps, such as Facebook Messaging or slack.com. Productivity may refer to office applications, such as Microsoft Word, Google Sheets, or Apple iWork. Social media may include various social media platforms, such as Instagram, Facebook, or Twitter.

The “common hostname” attribute refers to the specific service or application in use during the filesystem event. In an example, the “common hostname” attribute may have values of a domain name, subdomain, or URL. While the “vector” attribute identifies a platform domain, vendor, manufacturer, software provider, cloud provider, or service provider, the common hostname attribute is used to more specifically identify the service or application of a platform domain, vendor, manufacturer, software provider, cloud provider, or service provider. For example, when a user emails an attachment that may include sensitive information through Google Mail, the “vector” attribute (platform domain) may be identified as “google.com” and the “common hostname” attribute may be identified as “mail.google.com.” An administrative interface may be used to set a common hostname(s) and its corresponding vector(s).

To derive a vector from a common hostname, several operations may be used alone or in combination. One operation may be to discard meaningless platform divisions. For instance, “app.linkedin.com” becomes “linkedin.com”. Another operation is to retain meaningful subdomains from major platforms. For instance, the common hostname “mail.google.com” is retained as a vector of “mail.google.com”. In other operations, country codes are accounted for and retained in the vector. For instance, “advertising.amazon.co.uk” becomes “amazon.co.uk”. Internet protocol (IP) addresses are unchanged. Other operations may be used to create meaningful aggregations for vector analysis. For instance, distinguishing between “app.linkedin.com” and “login.linkedin.com” is irrelevant and may be detrimental by making exfiltration analysis more difficult.

At 406, the process 400 stores the attributes in a data store. The data store may be a relational database. Various other processes may query and retrieve data from the data store to display in a graphical user interface, initiate additional processes to mitigate data exfiltration, create reports, or the like.

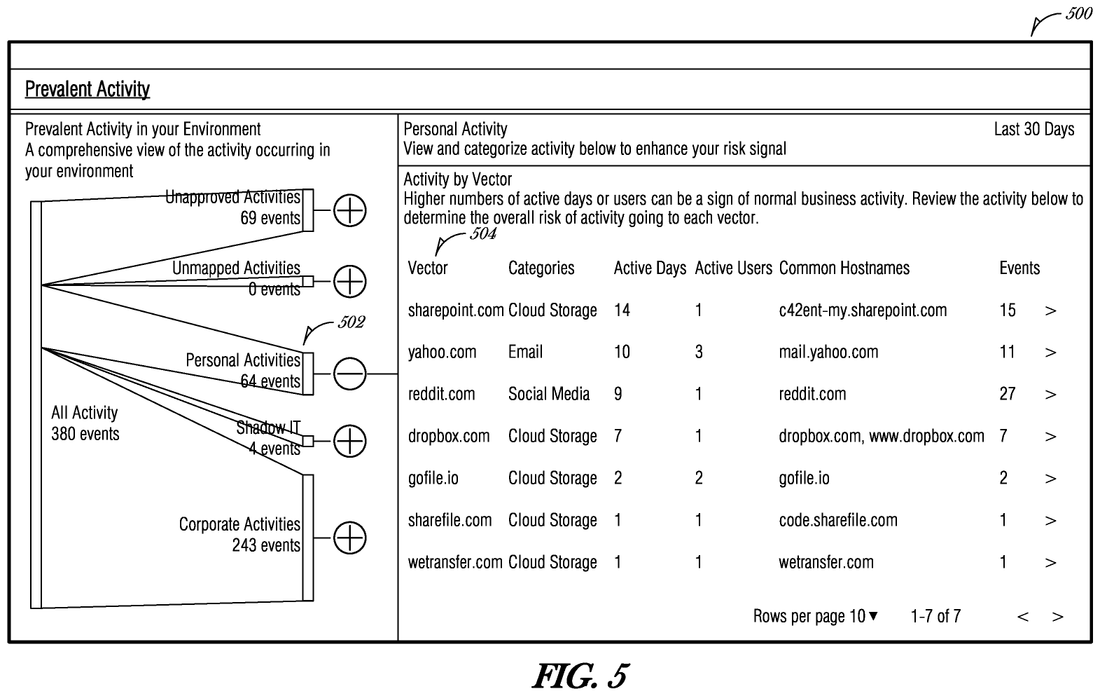

FIG. 5 is a diagram illustrating a user interface 500, according to an example. In the user interface 500 illustrated in FIG. 5, the “personal activity events” activity type 502 is expanded to display activities that are considered personal activity events. Here, the vectors 504 of the activities in the personal activity events 502 group are displayed with their corresponding categories, active days, active users, common hostnames, and event counts. An operator may interact with the user interface 500 to expand or collapse portions of the groups and subgroups. For instance, the operator may expand the “yahoo.com” vector to display the events in the “yahoo.com” vector. The detailed event view may include various event metadata, such as a filename, a file type, a source (e.g., a path, a directory, a network location, a source address (e.g., URL, IP address, email address, etc.), a source application, a source repository, a source file type, etc.), a destination (e.g., a path, a directory, a network location, a destination address (e.g., URL, IP address, email address, etc.), a destination application, a destination repository, a destination file type, etc.), a file operation (e.g., read, write, copy, paste, etc.), a user (e.g., an active user, a user account used to effect the file operation, etc.), a unique event identifier (ID), a date and time stamp, and the like.

The user interface 500 coalesces application platforms, email destinations, and other aspects into vector-based activity tiers that reflect the type of use and data involved within an activity category. These tiers correspond to activity type attributes, as discussed above. Activity type-based tiers are useful to reduce the amount of visual clutter and define manageable views of activity that support expedient and efficient exploration. In addition, defined activity type tiers enable interaction policies that elevate risk when data crosses tier boundaries. For instance, data that moves from a corporate activity type to a personal activity type may indicate a potential exfiltration.

The activity type tiers are the highest grouping with application destinations, email destinations, and local activities being grouped in the next subgroup, vector. The vector group, represented by the vector attribute as discussed above, can be used throughout the operator's environment to represent a data pathway used during a filesystem event.

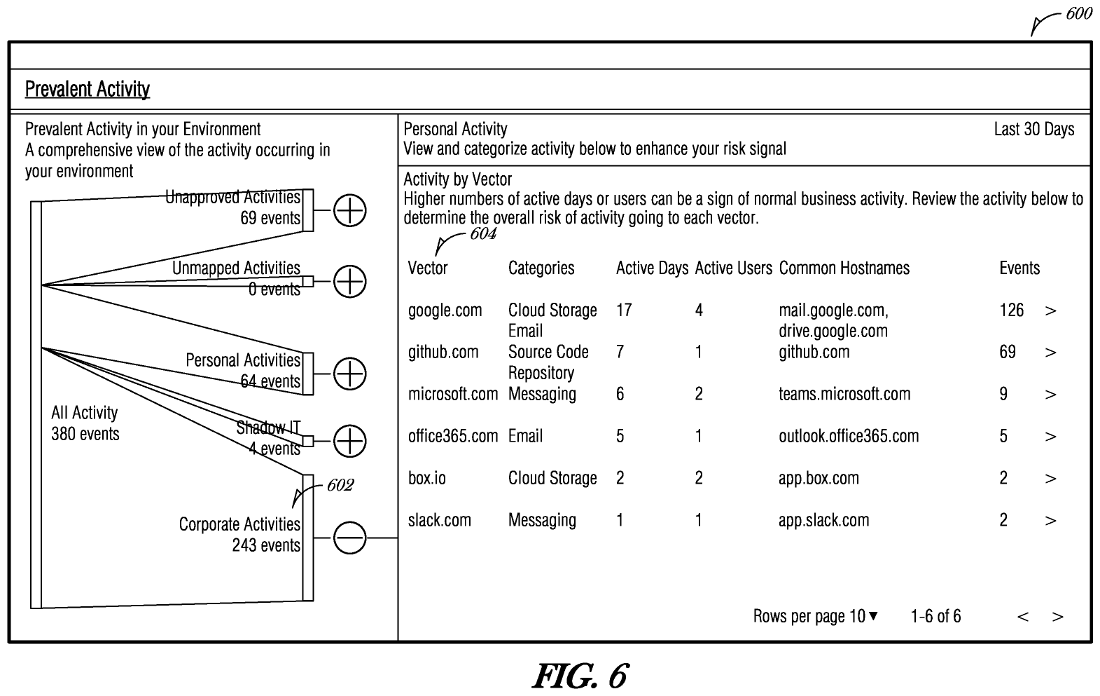

FIG. 6 is a diagram illustrating another user interface 600, according to an example. In the user interface 600 illustrated in FIG. 6, the “corporate activity events” activity type 602 is expanded to display activities that are considered corporate activity events. Here, the vectors 604 of the activities in the corporate activity events 602 group are displayed with their corresponding categories, active days, active users, common hostnames, and event counts. As with the user interface 500 described in FIG. 5, the operator may interact with the user interface 600 to expand or collapse portions of the groups and subgroups. For instance, the operator may expand the “google.com” vector to display some or all 126 events in the “google.com” vector.

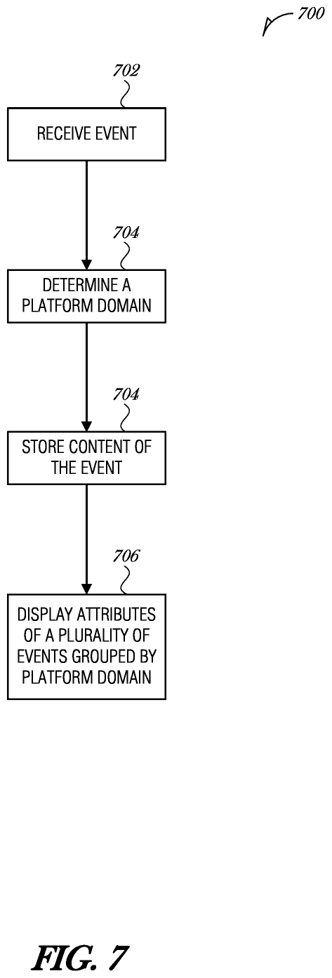

FIG. 7 illustrates an example of a process 700 for generating a user interface, according to an example. The process 700 can be implemented by a user device, an administrative device (e.g., operator computer resource 118), a client device (e.g., client device 102), or any other suitable component of the systems described herein. The process 700 may generate a user interface, such as one illustrated in FIG. 5 or 6.

At 702, an indication of a filesystem event detected by an event monitor is received. In an embodiment, the event monitor is configured to interface with a web browser to detect filesystem events. In another embodiment, the event monitor is configured to interface with a kernel filter to detect filesystem events. In another embodiment, the event monitor is configured to interface with an event stream to detect filesystem events. In another embodiment, the event monitor uses calculated hash values for files it monitors to detect when a file experiences the filesystem event. In another embodiment, the event monitor uses calculated hash values for files it monitors to detect when contents of a file experience the filesystem event.

At 704, a platform domain is determined from the indication of the filesystem event. In an embodiment, determining the platform domain from the indication of the filesystem event comprises parsing a destination network location associated with the filesystem event.

In another embodiment, determining the platform domain from the indication of the filesystem event comprises interfacing with a domain name system (DNS) server to verify that the platform domain is registered with the DNS server.

At 706, content of the filesystem event is stored in a data store with content from a plurality of filesystem events.

At 708, attributes of the plurality of filesystem events, grouped by platform domain, are displayed in a graphical user interface.

In an embodiment, the method 700 includes categorizing the plurality of filesystem events into risk categories and displaying in the graphical user interface, the plurality of filesystem events grouped by the risk categories.

In an embodiment, the method 700 includes categorizing the plurality of filesystem events as being related to either personal activity or corporate activity and displaying in the graphical user interface, a first subset of the plurality of filesystem events grouped by personal activity and a second subset of the plurality of filesystem events grouped by corporate activity.

In an embodiment, the method 700 includes determining from the indication of the filesystem event, a common hostname related to the platform domain and displaying in the graphical user interface, the common hostname and the platform domain.

In an embodiment, the method 700 includes determining prevalent platform domains of the plurality of filesystem events and filtering platform domains displayed in the graphical user interface to those that are prevalent. In a further embodiment, determining prevalent platform domains includes determining a number of filesystem events that are related to a given platform domain and marking the given platform domain as a prevalent platform domain when the number of filesystem events exceeds a threshold number.

In another embodiment, determining prevalent platform domains includes determining a number of users associated with filesystem events that are related to a given platform domain and marking the given platform domain as a prevalent platform domain when the number of users exceeds a threshold number.

The processes described herein can include any other steps or operations for implementing the techniques of the present disclosure. Further, while the operations processes described in the discussed processes are shown as happening sequentially in a specific order, in other examples, one or more of the operations may be performed in parallel or in a different order. Additionally, one or more operations may be repeated two or more times.

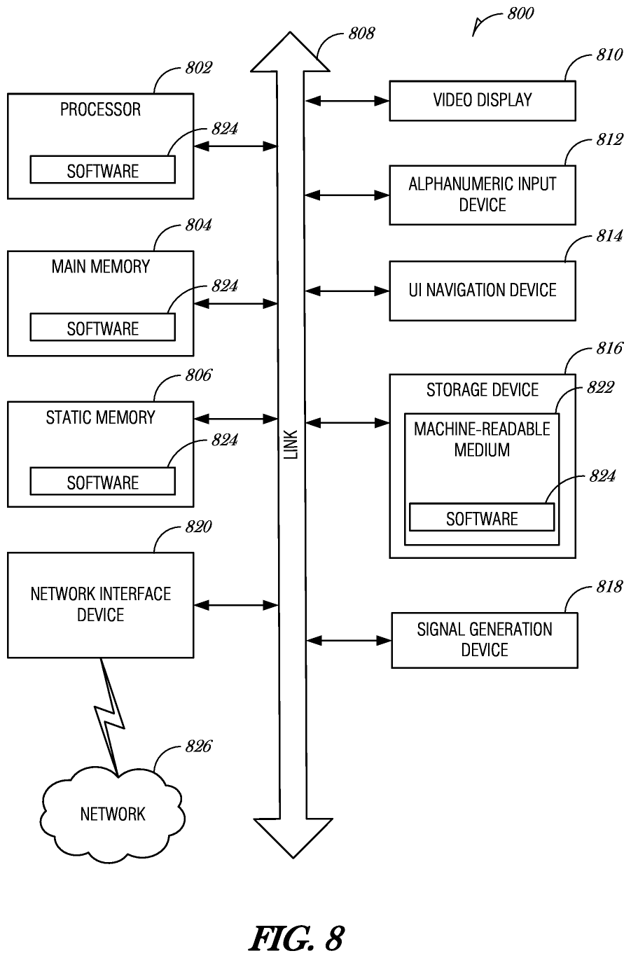

FIG. 8 illustrates a diagrammatic representation of a machine in the form of a computer system within which a set of instructions may be executed for causing the machine to perform any one or more of the methodologies discussed herein, according to an example. The computer system 800 is an example of one or more of the computing resources discussed herein.

In alternative examples, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 800 includes at least one processor 802 (e.g., a central processing unit (CPU), a graphics processing unit (GPU) or both, processor cores, compute nodes, etc.), a main memory 804 and a static memory 806, which communicate with each other via a link 808 (e.g., bus). The computer system 800 may further include a video display unit 810, an alphanumeric input device 812 (e.g., a keyboard), and a user interface (UI) navigation device 814 (e.g., a mouse). In one example, the video display unit 810, input device 812 and UI navigation device 814 are incorporated into a touch screen display. The computer system 800 may additionally include a storage device 816 (e.g., a drive unit), such as a global positioning system (GPS) sensor, compass, accelerometer, gyrometer, magnetometer, or other sensors.

The storage device 816 includes a machine-readable medium 822 on which is stored one or more sets of data structures and instructions 824 (e.g., software) embodying or utilized by any one or more of the methodologies or functions described herein. In an example, the one or more instructions 824 can constitute an event monitor 110, the relationship agent service 115, the backup server 145, the query service 150, the related file analysis service 155, the large-token generator 170, or the analysis service 175, as described herein. The instructions 824 may also reside, completely or at least partially, within the main memory 804, static memory 806, and/or within the processor 802 during execution thereof by the computer system 800, with the main memory 804, static memory 806, and the processor 802 also constituting machine-readable media.

While the machine-readable medium 822 is illustrated in an example to be a single medium, the term “machine-readable medium” may include a single medium or multiple media (e.g., a centralized or distributed database, and/or associated caches and servers) that store the one or more instructions 824. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 824 may further be transmitted or received over a communications network 826 using a transmission medium via the network interface device 820 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Bluetooth, Wi-Fi, 3G, and 4G LTE/LTE-A, 5G, DSRC, or WiMAX networks). The term “transmission medium” shall be taken to include any intangible medium that is capable of storing, encoding, or carrying instructions for execution by the machine, and includes digital or analog communications signals or other intangible medium to facilitate communication of such software.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

Circuitry or circuits, as used in this document, may comprise, for example, singly or in any combination, hardwired circuitry, programmable circuitry such as computer processors comprising one or more individual instruction processing cores, state machine circuitry, and/or firmware that stores instructions executed by programmable circuitry. The circuits, circuitry, or modules may, collectively or individually, be embodied as circuitry that forms part of a larger system, for example, an integrated circuit (IC), system on-chip (SoC), desktop computers, laptop computers, tablet computers, servers, smart phones, etc.

As used in any example herein, the term “logic” may refer to firmware and/or circuitry configured to perform any of the aforementioned operations. Firmware may be embodied as code, instructions or instruction sets and/or data that are hard-coded (e.g., nonvolatile) in memory devices and/or circuitry.

The above detailed description includes references to the accompanying drawings, which form a part of the detailed description. The drawings show, by way of illustration, specific examples that may be practiced. These examples are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

Example 1 is a system comprising: a processor subsystem; and memory including instructions that, when executed by the processor subsystem, cause the processor subsystem to perform operations comprising: receiving an indication of a filesystem event detected by an event monitor; determining a platform domain from the indication of the filesystem event; storing content of the filesystem event in a data store with content from a plurality of filesystem events; and displaying in a graphical user interface, attributes of the plurality of filesystem events, grouped by platform domain.

In Example 2, the subject matter of Example 1 includes, wherein the event monitor is configured to interface with a web browser to detect filesystem events.

In Example 3, the subject matter of Examples 1-2 includes, wherein the event monitor is configured to interface with a kernel filter to detect filesystem events.

In Example 4, the subject matter of Examples 1-3 includes, wherein the event monitor is configured to interface with an event stream to detect filesystem events.

In Example 5, the subject matter of Examples 1-4 includes, wherein the event monitor uses calculated hash values for files it monitors to detect when a file experiences the filesystem event.

In Example 6, the subject matter of Examples 1-5 includes, wherein the event monitor uses calculated hash values for files it monitors to detect when contents of a file experience the filesystem event.

In Example 7, the subject matter of Examples 1-6 includes, wherein determining the platform domain from the indication of the filesystem event comprises parsing a destination network location associated with the filesystem event.

In Example 8, the subject matter of Examples 1-7 includes, wherein determining the platform domain from the indication of the filesystem event comprises interfacing with a domain name system (DNS) server to verify that the platform domain is registered with the DNS server.

In Example 9, the subject matter of Examples 1-8 includes, categorizing the plurality of filesystem events into risk categories; and displaying in the graphical user interface, the plurality of filesystem events grouped by the risk categories.

In Example 10, the subject matter of Examples 1-9 includes, categorizing the plurality of filesystem events as being related to either personal activity or corporate activity; and displaying in the graphical user interface, a first subset of the plurality of filesystem events grouped by personal activity and a second subset of the plurality of filesystem events grouped by corporate activity.

In Example 11, the subject matter of Examples 1-10 includes, determining from the indication of the filesystem event, a common hostname related to the platform domain; and displaying in the graphical user interface, the common hostname and the platform domain.

In Example 12, the subject matter of Examples 1-11 includes, determining prevalent platform domains of the plurality of filesystem events; and filtering platform domains displayed in the graphical user interface to those that are prevalent.

In Example 13, the subject matter of Example 12 includes, wherein determining prevalent platform domains comprises: determining a number of filesystem events that are related to a given platform domain; and marking the given platform domain as a prevalent platform domain when the number of filesystem events exceeds a threshold number.

In Example 14, the subject matter of Examples 12-13 includes, wherein determining prevalent platform domains comprises: determining a number of users associated with filesystem events that are related to a given platform domain; and marking the given platform domain as a prevalent platform domain when the number of users exceeds a threshold number.

Example 15 is a method comprising: receiving an indication of a filesystem event detected by an event monitor; determining a platform domain from the indication of the filesystem event; storing content of the filesystem event in a data store with content from a plurality of filesystem events; and displaying in a graphical user interface, attributes of the plurality of filesystem events, grouped by platform domain.

In Example 16, the subject matter of Example 15 includes, wherein the event monitor is configured to interface with a web browser to detect filesystem events.

In Example 17, the subject matter of Examples 15-16 includes, wherein the event monitor is configured to interface with a kernel filter to detect filesystem events.

In Example 18, the subject matter of Examples 15-17 includes, wherein the event monitor is configured to interface with an event stream to detect filesystem events.

In Example 19, the subject matter of Examples 15-18 includes, wherein the event monitor uses calculated hash values for files it monitors to detect when a file experiences the filesystem event.

In Example 20, the subject matter of Examples 15-19 includes, wherein the event monitor uses calculated hash values for files it monitors to detect when contents of a file experience the filesystem event.

In Example 21, the subject matter of Examples 15-20 includes, wherein determining the platform domain from the indication of the filesystem event comprises parsing a destination network location associated with the filesystem event.

In Example 22, the subject matter of Examples 15-21 includes, wherein determining the platform domain from the indication of the filesystem event comprises interfacing with a domain name system (DNS) server to verify that the platform domain is registered with the DNS server.

In Example 23, the subject matter of Examples 15-22 includes, categorizing the plurality of filesystem events into risk categories; and displaying in the graphical user interface, the plurality of filesystem events grouped by the risk categories.

In Example 24, the subject matter of Examples 15-23 includes, categorizing the plurality of filesystem events as being related to either personal activity or corporate activity; and displaying in the graphical user interface, a first subset of the plurality of filesystem events grouped by personal activity and a second subset of the plurality of filesystem events grouped by corporate activity.

In Example 25, the subject matter of Examples 15-24 includes, determining from the indication of the filesystem event, a common hostname related to the platform domain; and displaying in the graphical user interface, the common hostname and the platform domain.

In Example 26, the subject matter of Examples 15-25 includes, determining prevalent platform domains of the plurality of filesystem events; and filtering platform domains displayed in the graphical user interface to those that are prevalent.

In Example 27, the subject matter of Example 26 includes, wherein

determining prevalent platform domains comprises: determining a number of filesystem events that are related to a given platform domain; and marking the given platform domain as a prevalent platform domain when the number of filesystem events exceeds a threshold number.

In Example 28, the subject matter of Examples 26-27 includes, wherein determining prevalent platform domains comprises: determining a number of users associated with filesystem events that are related to a given platform domain; and marking the given platform domain as a prevalent platform domain when the number of users exceeds a threshold number.

Example 29 is a non-transitory machine-readable medium including instructions, which when executed by a machine, cause the machine to perform operations comprising: receiving an indication of a filesystem event detected by an event monitor; determining a platform domain from the indication of the filesystem event; storing content of the filesystem event in a data store with content from a plurality of filesystem events; and displaying in a graphical user interface, attributes of the plurality of filesystem events, grouped by platform domain.

In Example 30, the subject matter of Example 29 includes, wherein the event monitor is configured to interface with a web browser to detect filesystem events.

In Example 31, the subject matter of Examples 29-30 includes, wherein the event monitor is configured to interface with a kernel filter to detect filesystem events.

In Example 32, the subject matter of Examples 29-31 includes, wherein the event monitor is configured to interface with an event stream to detect filesystem events.

In Example 33, the subject matter of Examples 29-32 includes, wherein the event monitor uses calculated hash values for files it monitors to detect when a file experiences the filesystem event.

In Example 34, the subject matter of Examples 29-33 includes, wherein the event monitor uses calculated hash values for files it monitors to detect when contents of a file experience the filesystem event.

In Example 35, the subject matter of Examples 29-34 includes, wherein determining the platform domain from the indication of the filesystem event comprises parsing a destination network location associated with the filesystem event.

In Example 36, the subject matter of Examples 29-35 includes, wherein determining the platform domain from the indication of the filesystem event comprises interfacing with a domain name system (DNS) server to verify that the platform domain is registered with the DNS server.

In Example 37, the subject matter of Examples 29-36 includes, wherein the instructions cause the machine to perform operations comprising: categorizing the plurality of filesystem events into risk categories; and displaying in the graphical user interface, the plurality of filesystem events grouped by the risk categories.

In Example 38, the subject matter of Examples 29-37 includes, wherein the instructions cause the machine to perform operations comprising: categorizing the plurality of filesystem events as being related to either personal activity or corporate activity; and displaying in the graphical user interface, a first subset of the plurality of filesystem events grouped by personal activity and a second subset of the plurality of filesystem events grouped by corporate activity.

In Example 39, the subject matter of Examples 29-38 includes, wherein the instructions cause the machine to perform operations comprising: determining from the indication of the filesystem event, a common hostname related to the platform domain; and displaying in the graphical user interface, the common hostname and the platform domain.

In Example 40, the subject matter of Examples 29-39 includes, wherein the instructions cause the machine to perform operations comprising: determining prevalent platform domains of the plurality of filesystem events; and filtering platform domains displayed in the graphical user interface to those that are prevalent.

In Example 41, the subject matter of Example 40 includes, wherein determining prevalent platform domains comprises: determining a number of filesystem events that are related to a given platform domain; and marking the given platform domain as a prevalent platform domain when the number of filesystem events exceeds a threshold number.

In Example 42, the subject matter of Examples 40-41 includes, wherein determining prevalent platform domains comprises: determining a number of users associated with filesystem events that are related to a given platform domain; and marking the given platform domain as a prevalent platform domain when the number of users exceeds a threshold number.

Example 43 is at least one machine-readable medium including instructions that, when executed by processing circuitry, cause the processing circuitry to perform operations to implement of any of Examples 1-42.

Example 44 is an apparatus comprising means to implement of any of Examples 1-42.

Example 45 is a system to implement of any of Examples 1-42.

Example 46 is a method to implement of any of Examples 1-42.

The above description is intended to be illustrative, and not restrictive. For example, the above-described examples (or one or more aspects thereof) may be used in combination with others. Other examples may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as examples may feature a subset of said features. Further, examples may include fewer features than those disclosed in a particular example. Thus, the following claims are hereby incorporated into the Detailed Description, with a claim standing on its own as a separate example. The scope of the examples disclosed herein is to be determined with reference to the appended claims, along with the full scope of equivalents to which such claims are entitled.

What is claimed is:

1. A system comprising:
a processor subsystem; and
memory including instructions that, when executed by the processor subsystem, cause the processor subsystem to perform operations comprising:
receiving an indication of a filesystem event detected by an event monitor;
determining a platform domain from the indication of the filesystem event;
storing content of the filesystem event in a data store with content from a plurality of filesystem events; and
displaying in a graphical user interface, attributes of the plurality of filesystem events, grouped by platform domain.

2. The system of claim 1, wherein the event monitor is configured to interface with a web browser to detect filesystem events.

3. The system of claim 1, wherein the event monitor is configured to interface with a kernel filter to detect filesystem events.

4. The system of claim 1, wherein the event monitor is configured to interface with an event stream to detect filesystem events.

5. The system of claim 1, wherein the event monitor uses calculated hash values for files it monitors to detect when a file experiences the filesystem event.

6. The system of claim 1, wherein the event monitor uses calculated hash values for files it monitors to detect when contents of a file experience the filesystem event.

7. The system of claim 1, wherein determining the platform domain from the indication of the filesystem event comprises parsing a destination network location associated with the filesystem event.

8. The system of claim 1, wherein determining the platform domain from the indication of the filesystem event comprises interfacing with a domain name system (DNS) server to verify that the platform domain is registered with the DNS server.

9. The system of claim 1, further comprising:
categorizing the plurality of filesystem events into risk categories; and
displaying in the graphical user interface, the plurality of filesystem events grouped by the risk categories.

10. The system of claim 1, further comprising:
categorizing the plurality of filesystem events as being related to either personal activity or corporate activity; and
displaying in the graphical user interface, a first subset of the plurality of filesystem events grouped by personal activity and a second subset of the plurality of filesystem events grouped by corporate activity.

11. The system of claim 1, further comprising:
determining from the indication of the filesystem event, a common hostname related to the platform domain; and
displaying in the graphical user interface, the common hostname and the platform domain.

12. The system of claim 1, further comprising:
determining prevalent platform domains of the plurality of filesystem events; and
filtering platform domains displayed in the graphical user interface to those that are prevalent.

13. The system of claim 12, wherein determining prevalent platform domains comprises:
determining a number of filesystem events that are related to a given platform domain; and
marking the given platform domain as a prevalent platform domain when the number of filesystem events exceeds a threshold number.

14. The system of claim 12, wherein determining prevalent platform domains comprises:
determining a number of users associated with filesystem events that are related to a given platform domain; and
marking the given platform domain as a prevalent platform domain when the number of users exceeds a threshold number.

15. A method comprising:
receiving an indication of a filesystem event detected by an event monitor;
determining a platform domain from the indication of the filesystem event;
storing content of the filesystem event in a data store with content from a plurality of filesystem events; and
displaying in a graphical user interface, attributes of the plurality of filesystem events, grouped by platform domain.

16. The method of claim 15, further comprising:
categorizing the plurality of filesystem events into risk categories; and
displaying in the graphical user interface, the plurality of filesystem events grouped by the risk categories.

17. The method of claim 15, further comprising:
categorizing the plurality of filesystem events as being related to either personal activity or corporate activity; and
displaying in the graphical user interface, a first subset of the plurality of filesystem events grouped by personal activity and a second subset of the plurality of filesystem events grouped by corporate activity.

18. The method of claim 15, further comprising:
determining from the indication of the filesystem event, a common hostname related to the platform domain; and
displaying in the graphical user interface, the common hostname and the platform domain.

19. A non-transitory machine-readable medium including instructions, which when executed by a machine, cause the machine to perform operations comprising:
receiving an indication of a filesystem event detected by an event monitor;
determining a platform domain from the indication of the filesystem event;
storing content of the filesystem event in a data store with content from a plurality of filesystem events; and
displaying in a graphical user interface, attributes of the plurality of filesystem events, grouped by platform domain.

20. The non-transitory machine-readable medium of claim 19, wherein the instructions cause the machine to perform operations comprising:
determining prevalent platform domains of the plurality of filesystem events; and
filtering platform domains displayed in the graphical user interface to those that are prevalent.
